(19) United States
(12) Patent Application Publication
(10) Pub. No.: US 2014/0149212 A1
(43) Pub. Date: May 29, 2014

(54) ADVERTISEMENT DELIVERY MANAGEMENT APPARATUS AND ADVERTISEMENT DELIVERY MANAGEMENT METHOD

(71) Applicant: YAHOO JAPAN CORPORATION, Tokyo (JP)

(72) Inventors: Kazuhiko SHIMURA, Tokyo (JP); Koji TSUKAMOTO, Tokyo (JP)

(73) Assignee: YAHOO JAPAN CORPORATION, Tokyo (JP)

(21) Appl. No.: 14/086,604

(22) Filed: Nov. 21, 2013

(30) Foreign Application Priority Data
Nov. 27, 2012 (JP) 2012-258788

(51) Int. Cl. G06Q 30/02

(52) U.S. Cl. CPC G06Q 30/0254; G06Q 30/0269
USPC 705/14.52

(57) ABSTRACT

An advertisement delivery management apparatus according to the present disclosure includes a score determining unit and an allocating unit. The score determining unit determines an allocation score representing a adequacy degree of allocation of a delivery target user on an advertisement delivery order request based on the number or the proportion of non-allocated users which are delivery target users which are not allocated on the advertisement delivery order request among a plurality of delivery target users for each user attribute. The allocating unit allocates the delivery target user on the advertisement delivery order request so that a decrease in the allocation score is minimized before and after the delivery target user is allocated on the order request for the advertisement delivery order request.

### CROSS-REFERENCE TO RELATED APPLICATIONS

The present application claims priority to and incorporates by reference the entire contents of Japanese Patent Application No. 2012-258788 filed in Japan on Nov. 27, 2012.

### BACKGROUND OF THE INVENTION

1. Field of the Invention

The present invention relates to an advertisement delivery management apparatus and an advertisement delivery management method.

2. Description of the Related Art

In recent years, with the rapid spread of a network such as the Internet, advertisement delivery using a network has been actively performed. As a form of such advertisement delivery, known is display advertising of displaying an advertisement using an image, a video, or the like on a certain space in a page (hereinafter, referred to as an “advertisement delivery target page”) of an advertisement delivery target.

In the display advertising, an advertisement is delivered to a user having a user attribute (a sex, an age, an interest, or the like) designated by an advertiser, and thus effective advertisement delivery is performed (for example, see Japanese Laid-open Patent Publication N 2011-238020).

In the above-mentioned advertisement delivery, when the user attribute of the user who accessed the advertisement delivery target page is identical to the user attribute designated by the advertiser, an advertisement is delivered. Thus, it is desirable to predict a delivery target user who is a future advertisement delivery destination as a future log together with a user attribute and accept an order from the advertiser based on the future log.

However, when the delivery target user of the future advertisement delivery destination has a plurality of user attributes, there are cases in which it is difficult to accept a new order from the advertiser depending on a method of allocating the delivery target user on the advertisement delivery order.

### SUMMARY OF THE INVENTION

According to an exemplary embodiment, an advertisement delivery management apparatus includes a predictive information storage, a score determining unit, and an allocating unit. The predictive information storage stores predictive information including user attributes of a plurality of delivery target users predicted as a future advertisement delivery destination. The score determining unit determines an allocation score representing a adequacy degree of allocation of a delivery target user on an advertisement delivery order request based on the number or the proportion of non-allocated users which are delivery target users which are not allocated on the advertisement delivery order request among the plurality of delivery target users for each user attribute. The allocating unit allocates the delivery target user on the advertisement delivery order request so that a decrease in the allocation score is minimized before and after the delivery target user is allocated on the advertisement delivery order request.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIGS. 1A and 1B are explanatory views of an advertisement delivery management process according to an embodiment;

FIG. 2 is a diagram illustrating a configuration of an advertisement delivery management apparatus according to an embodiment;

FIG. 3 is a diagram illustrating an exemplary advertising information table;

FIG. 4 is a diagram illustrating an exemplary user information table;

FIG. 5 is a diagram illustrating an exemplary access log table;

FIG. 6 is a diagram illustrating an exemplary future log table;

FIG. 7 is a diagram illustrating an advertisement delivery management process flow of an advertisement delivery management apparatus according to an embodiment; and

FIG. 8 is a diagram illustrating an exemplary allocation process flow of an advertisement delivery management apparatus according to an embodiment.

### DETAILED DESCRIPTION OF THE PREFERRED EMBODIMENTS

Hereinafter, a mode (hereinafter, referred to as an “embodiment”) for carrying out an advertisement delivery management apparatus and an advertisement delivery management method according to the present disclosure will be described in detail with reference to the appended drawings. The following embodiment is not intended to limit the advertisement delivery management apparatus and the advertisement delivery management method according to the present disclosure. Further, “database” is hereinafter referred as a “DB.”

### 1. Advertisement Delivery Management Process

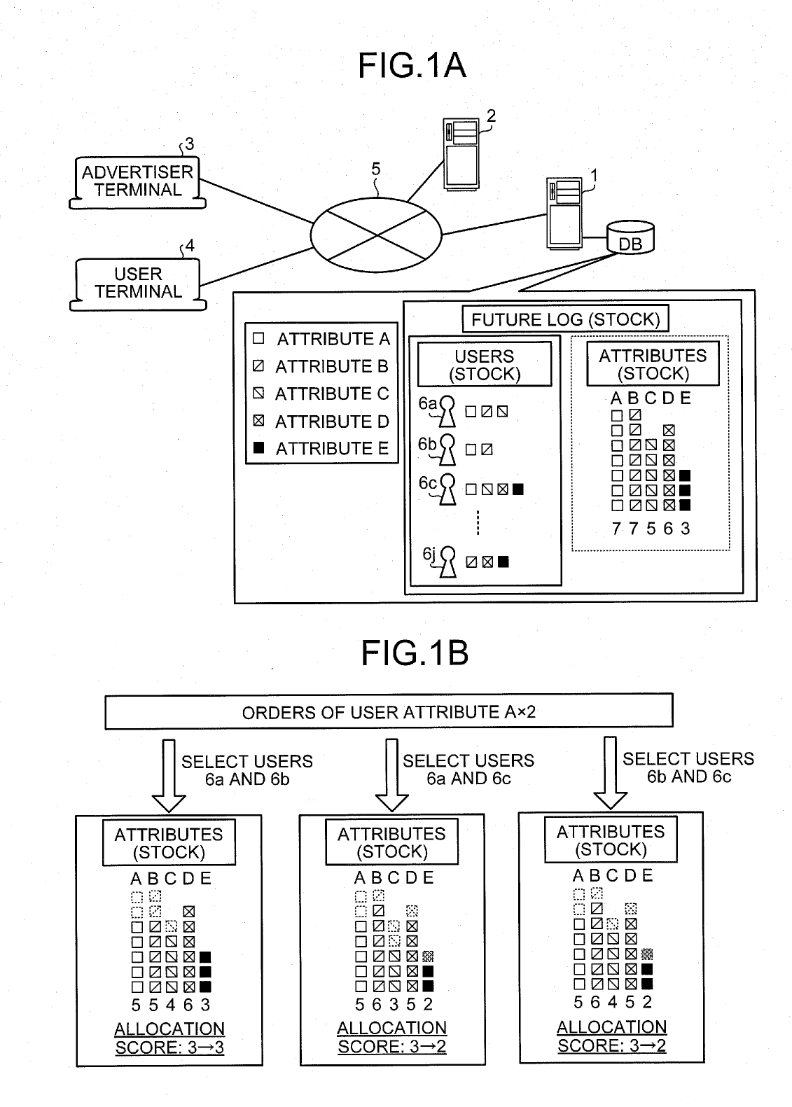

First of all, an advertisement delivery management process according to an embodiment will be described. FIGS. 1A and 1B are explanatory views of the advertisement delivery management process according to an embodiment, and a delivery target user is appropriately allocated to an order received from an advertiser through the advertisement delivery management process.

An advertisement delivery management system according to an embodiment includes an advertisement delivery management apparatus 1 (which corresponds to an example of an advertisement delivery management apparatus), an information delivery apparatus 2, an advertiser terminal 3, and a user terminal 4 as illustrated in FIG. 1A. The advertisement delivery management apparatus 1, the information delivery apparatus 2, the advertiser terminal 3, and the user terminal 4 are connected with one another via a communication network 5. For example, the communication network 5 is an Internet protocol (IP).network such as the Internet. There are a plurality of advertiser terminals 3 and a plurality of user terminals 4, but in FIG. 1A, one advertiser terminal 3 and one user terminal 4 are illustrated for convenience of description.

The advertiser terminal 3 is a terminal apparatus of an advertiser who desires to do advertisement delivery, and transmits an order (hereinafter, referred to as an “order request”) of an advertisement, which is desired to be delivered to the user terminal 4 of a user having a certain user attribute, to the advertisement delivery management apparatus 1. Specifically, the advertiser terminal 3 transmits an order request including advertising information which the advertiser desires to post on an advertisement delivery target page and information of a user attribute to be designated as a delivery destination to the advertisement delivery management apparatus 1. The advertising information includes, for example, a two-dimensional (2D) content or a three-dimensional (3D) content such as a banner advertisement, a text advertisement, or a video advertisement.

The user terminal 4 is a terminal apparatus of a user who accesses the advertisement delivery management apparatus 1 and the information delivery apparatus 2. When accessed by the user terminal 4, the information delivery apparatus 2 transmits an advertisement delivery target page such as a web page to the user terminal 4. The advertisement delivery target page includes a uniform resource locator (URL) of the advertising information, and the user terminal 4 transmits an advertisement request to the advertisement delivery management apparatus 1 based on the URL.

The advertisement delivery management apparatus 1 performs a process from acceptance of the advertisement delivery order to delivery thereof by performing a process of accepting an order request, a process of allocating a user attribute on the accepted order request, and a process of delivering advertising information designated by the order request.

The advertisement delivery management apparatus 1 stores information including user attributes of a plurality of delivery target users predicted as the future advertisement delivery destination in a DB as a future log (predictive information), and performs the order request acceptance process and the user attribute allocation process based on the future log.

In the example illustrated in FIG. 1A, information including user attributes of delivery target users 6a, 6d, 6c, . . . , and 6j in a DB as a future log. For example, the delivery target user 6a has user attributes A, B, and C, the delivery target user 6b has the user attributes A and B, the delivery target user 6c has the user attributes A and C to E, and the delivery target user 6j has the user attributes B, D, and E.

The advertisement delivery management apparatus 1 determines an allocation score representing an adequacy degree of the allocation of the delivery target user on the advertisement delivery order request based on the number or the proportion of the delivery target users (which are hereinafter referred to as “non-allocated users” as well) 6a to 6j which are not allocated on the order request for each user attribute.

Further, the advertisement delivery management apparatus 1 allocates the delivery target user on the advertisement delivery order request so that a decrease in the allocation score is minimized before and after the delivery target user is allocated on the advertisement delivery order request.

For example, the advertisement delivery management apparatus 1 obtains the number or the proportion of the non-allocated users for each user attribute, and decides a user attribute which is smallest in the number or the proportion of the non-allocated users as a score determination user attribute.

In the future log illustrated in FIG. 1A, there are five user attributes “A” to “E,” each of the number of delivery target users having the user attribute A and the number of delivery target users having the user attribute B is 7, the number of delivery target users having the user attribute C is 5, the number of delivery target users having the user attribute D is 6, and the number of delivery target users having the user attribute E is 3. Thus, the advertisement delivery management apparatus 1 decides the user attribute E which is smallest in the number and the proportion of the non-allocated users as the score determination user attribute.

Further, the advertisement delivery management apparatus 1 determines the number or the proportion of the delivery target users having the score determination user attribute as the allocation score. The delivery target user is allocated on the advertisement delivery order request so that a decrease in the allocation score is minimized.

Here, an example in which any one of the delivery target users 6a and 6b, the delivery target users 6a and 6c, and the delivery target users 6b and 6c is allocated as the delivery target user allocated on the order request designating the user attribute A and the number of postings “2” as illustrated in FIG. 1B is considered.

When the order request is allocated to the delivery target users 6a and 6b, the allocation score is “3” without change, and when the order request is allocated to the delivery target users 6a and 6c or the delivery target users 6b and 6c, the allocation score decreases from “3” to “2.”

Thus, a combination of the delivery target users 6a and 6b is smallest in the decrease in the allocation score, and the advertisement delivery management apparatus 1 decides the delivery target users 6a and 6b as the delivery target user to be allocated on the order request. Through the above-described operation, it is possible to increase a possibility that the order request designating the user attribute which is smallest in the number or the proportion of the non-allocated users will be accepted, and it is possible to suppress sales opportunity loss.

Further, a certain condition used to decide a delivery target user allocated on the advertisement delivery order is not limited to a condition such as the allocation score based on the user attribute which is smallest in the number or the proportion of the non-allocated users, and various kinds of conditions which will be described later can be set.

Hereinafter, a concrete configuration and a detailed process of the advertisement delivery management apparatus 1 which performs the advertisement delivery management process will be described with reference to the appended drawings.

### 2. Configuration of Advertisement Delivery Management Apparatus 1

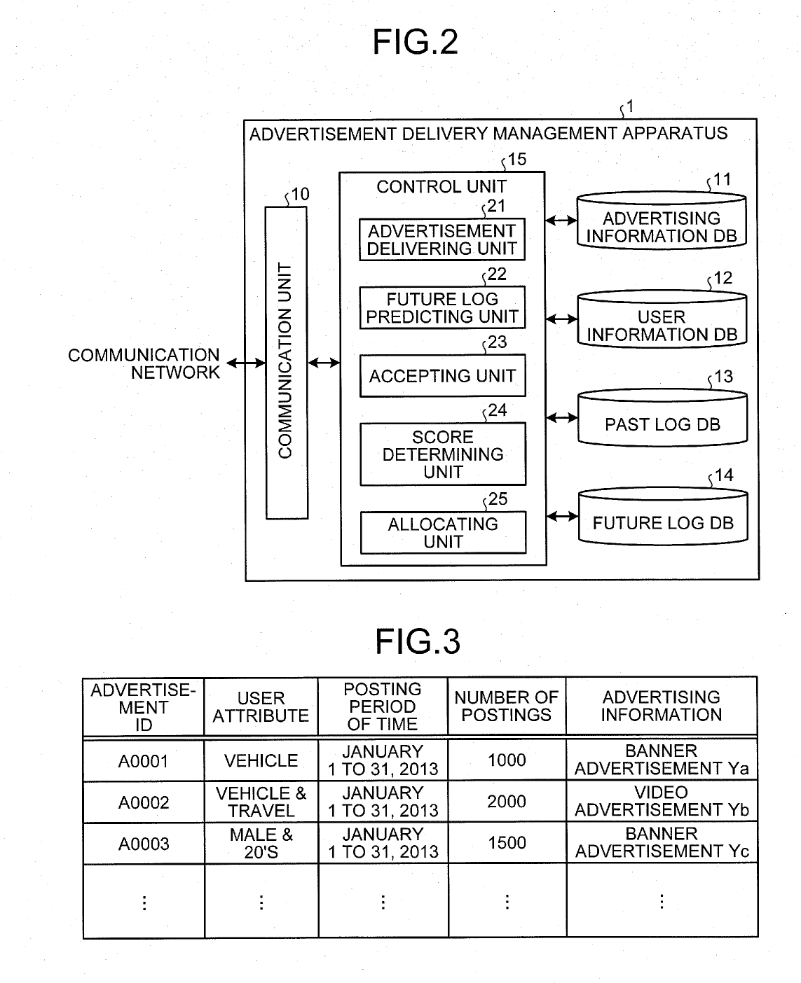

FIG. 2 is a diagram illustrating a configuration of the advertisement delivery management apparatus 1 according to an embodiment. The advertisement delivery management apparatus 1 includes a communication unit 10, an advertising information DB 11, a user information DB 12, a past log DB 13, a future log DB 14, and a control unit 15 as illustrated in FIG. 2. The control unit 15 includes an advertisement delivering unit 21, a future log predicting unit 22, an accepting unit 23, a score determining unit 24, and an allocating unit 25.

The communication unit 10 is an interface such as a network interface card (NIC). The control unit 15 transmits or receives various kinds of information to or from the advertiser terminal 3 or the user terminal 4 via the communication network 5 through the communication unit 10. The advertising information DB 11, the user information DB 12, the past log DB 13, and the future log DB 14 are implemented by hard disks, semiconductor memory devices such as random access memories (RAMs) or flash memories, or storage devices such as optical disks.

The control unit 15 is implemented by an integrated circuit (IC) such as an application specific integrated circuit (ASIC) or a field programmable gate array (FPGA). The control unit 15 functions as the advertisement delivering unit 21, the future log predicting unit 22, the accepting unit 23, the score determining unit 24, and the allocating unit 25 as a program stored in an internal storage device is executed by a central processing unit (CPU) or a micro processing unit (MPU) using a RAM as a work area. The configuration of the control unit 15 is not limited to the above configuration, and may have any other configuration capable of performing information processing which will be described later.

Advertisement Delivering Unit 21

When there is an advertising information delivery request from the user terminal 4, the advertisement delivering unit 21 acquires advertising information corresponding to the user attribute of the user of the user terminal 4 from the advertising information table of the advertising information DB 11, and transmits the acquired advertising information from the communication unit 10 to the user terminal 4 of the delivery request source.

FIG. 3 is a diagram illustrating an exemplary advertising information table stored in the advertising information DB 11. The advertising information table includes information associated with a “user attribute,” a “posting period of time,” the “number of postings,” and “advertising information” for each “advertisement ID” as illustrated in FIG. 3.

The “advertisement ID” is identification information allocated on each accepted order request. The “user attribute” is a user attribute designated by the order request, the “posting period of time” is a delivery period of time of advertising information designated by the order request, and the “number of postings” is the number of deliveries of the advertising information designated by the order request. Further, the “advertising information” is advertising information designated by the order request.

For example, an advertisement ID “A0001” represents that a user attribute of the delivery target is a “vehicle,” the delivery period of time of the advertising information is “January 1 to 31, 2013,” the number of deliveries of the advertising information is “1000 times,” and the advertising information is “banner advertisement Ya.” Further, when it is within the delivery period of time of the advertising information but the number of deliveries of the advertising information exceeds “1000 times,” the process of delivering the advertising information on the order request ends.

For example, when the user of the user terminal 4 who has made the advertising information delivery request has the user attribute “vehicle,” the advertisement delivering unit 21 acquires the advertising information “banner advertisement Ya” of the advertisement ID “A0001” from the advertising information table of the advertising information DB 11, and transmits the acquired advertising information “banner advertisement Ya” to the user terminal 4 of the delivery request source.

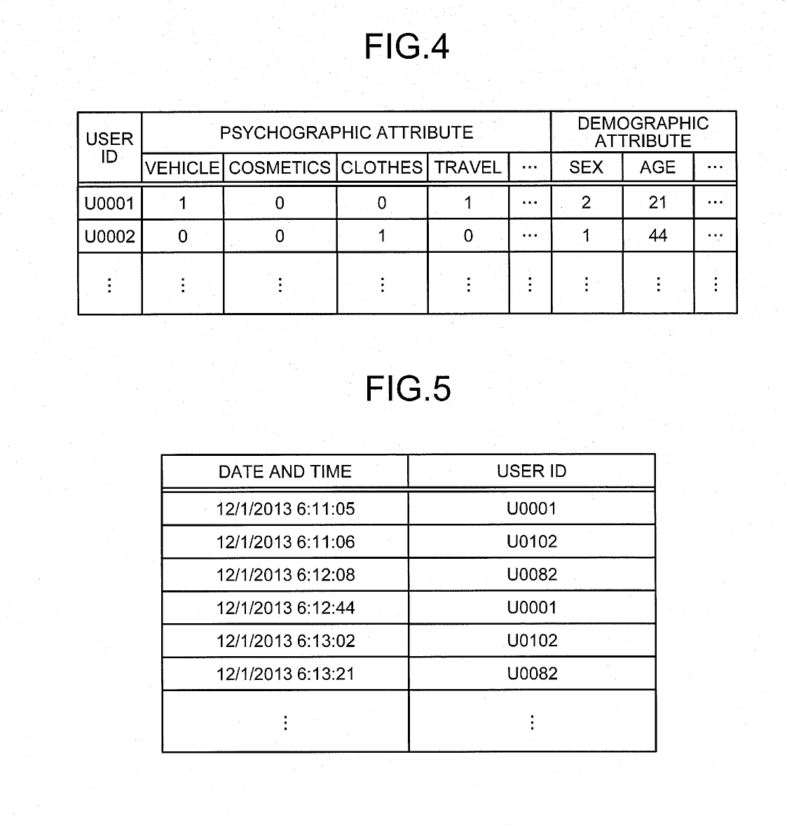

The user attribute of the user of the user terminal 4 is determined based on the user information table of the user information DB 12. FIG. 4 is a diagram illustrating an exemplary user information table stored in the user information DB 12. The user information table includes information such as a “user ID,” a “psychographic attribute,” and a “demographic attribute” as illustrated in FIG. 4.

The “user ID” is identification information used to identify the user using the user terminal 4. For example, the “user ID” corresponds to user identification information set to a hypertext transfer protocol cookie (HTTP cookie) exchanged between the advertisement delivery management apparatus 1 and the user terminal 4.

The “psychographic attribute” is information representing the user's value, lifestyle, character, preference, or the like. For example, the “psychographic attribute” is classified into attribute classifications such as “vehicle,” “cosmetics,” “clothes,” and “travel.” In the example illustrated in FIG. 4, when the user's preference is relatively high in each attribute classification, “1” is stored, and otherwise, “0” is stored. The “psychographic attribute” is not limited to the example of the attribute classifications illustrated in FIG. 4, and may include various kinds of attribute classifications such as an economy, politics, baseball, soccer, other sports, sweets, a personal computer (PC), white goods, and furniture.

The “demographic attribute” represents demographical user attribute information. For example, the “demographic attribute” is classified into attribute classifications such as “sex” and “age.” The “sex” illustrated in FIG. 4 stores “1” when the user is female and stores “2” when the user is male. Further, the “age” stores the user's age. The “demographic attribute” is not limited to the attribute classifications illustrated in FIG. 4, and may include various kinds of attribute classifications such as the user's occupation, family structure, annual income, address, hometown, and academic background.

For example, when the user of the user ID “U0001” illustrated in FIG. 4 has made the advertising information delivery request from the user terminal 4, the user's user attributes are determined to be “vehicle,” “travel,” “male,” “age of 21,” and the like. Further, for example, when the user of the user ID “U0002” illustrated in FIG. 4 has made the advertising information delivery request from the user terminal 4, the advertisement delivering unit 21 determines that the user's user attributes are “clothes,” “female,” “age of 44,” and the like.

Further, the advertisement delivering unit 21 sets the user ID of the user who has made the advertising information delivery request to the access log table of the past log DB 13. FIG. 5 is a diagram illustrating an exemplary access log table stored in the past log DB 13.

The access log table is a table to which information (which is hereinafter referred to as a “past log” as well) in which a date and time at which the user transmits the advertising information delivery request to the advertisement delivery management apparatus 1 is associated with the user ID is set as illustrated in FIG. 5. The advertisement delivering unit 21 updates the access log table each time the advertising information delivery request is received from the user terminal 4.

Future Log Predicting Unit 22

The future log predicting unit 22 determines a plurality of delivery target users predicted as a future advertisement delivery destination based on the access log table stored in the past log DB 13, and sets user information of the determined delivery target user to the future log table of the future log DB 14.

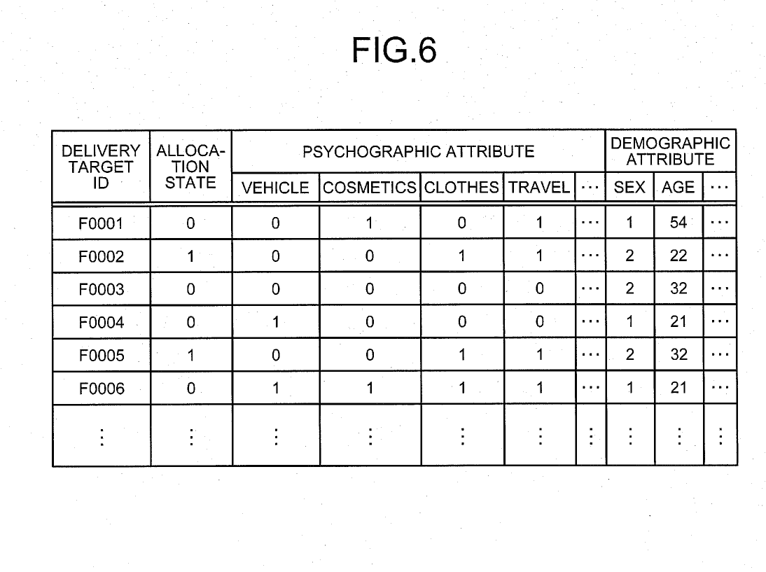

FIG. 6 is a diagram illustrating an exemplary future log table stored in the future log DB 14. Information (which is hereinafter referred to as a “future log” as well) related to a delivery target user predicted as an advertisement delivery destination during a certain future period of time is set to the future log table as illustrated in FIG. 6: The future log table illustrated in FIG. 6 includes future log information such as “delivery target ID,” “allocation state,” “psychographic attribute,” and “demographic attribute.”

The “delivery target ID” is identification information allocated for each delivery target user predicted as a future advertisement delivery destination. The delivery target user is a virtual user different from the user set to the user information table of the user information DB 12.

The “allocation state” is information representing whether a corresponding delivery target user is allocated on the order request. “1” is stored when the corresponding delivery target is allocated on the order request, but “0” is stored when the corresponding delivery target user is not allocated on the order request.

The “psychographic attribute” and the “demographic attribute” have the same items as in the user information table of the user information DB 12. Further, the user set to the user information table may be estimated as the delivery target user, and the user ID may be used as the delivery target ID. In this case, information of the “psychographic attribute” and the “demographic attribute” may be acquired from the user information table based on the user ID.

The future log predicting unit 22 may predict the delivery target user serving as the advertisement delivery destination during a certain future period of time based on access logs during the same period of time one year ago or access logs during a certain past period of time from the present. For example, the future log predicting unit 22 may estimate the user who has made the advertising information delivery request during past one month from the present as the delivery target user of a future one month.

Further, the future log predicting unit 22 may perform a statistical process on the past log set to the access log table, determine the tendency toward the delivery target user of the future advertisement delivery destination, and predict the future log based on the determination result. In this case, for example, the tendency of the delivery target user may be determined by additionally considering variation information such as the weather or the temperature.

Further, the future log predicting unit 22 can set the predicted future log to the future log table, but may set the future log acquired from an external apparatus through the communication unit 10 to the future log table.

Accepting Unit 23

The accepting unit 23 determines whether the order request received from the advertiser terminal 3 is to be accepted based on the future log set to the future log table, and transmits an order acceptance response to the advertiser terminal 3 when the order request is accepted.

The order request received from the advertiser terminal 3 includes designation information such as the user attribute and the number of postings. The accepting unit 23 counts the number of the non-allocated users having the user attribute designated by the order request among a plurality of delivery target users set to the future log table. When the counting result is the number of postings designated by the order request or more, the accepting unit 23 accepts the order request received from the advertiser terminal 3.

For example, when the user attribute designated by the order request is the “vehicle” and the number of postings “100,” the accepting unit 23 counts the number of delivery target users in which “1” is set to the attribute classification of the “vehicle” in the future log table. Then, the accepting unit 23 accepts the order request from the advertiser terminal 3 when the counting result is “100” or more, but the accepting unit 23 does not accept the order request from the advertiser terminal 3 when the counting result is currently less than “100.”

Further, the accepting unit 23 performs counting by regarding a combination of two or more user attributes in which the frequency of designation by the order request is a threshold value or more as one user attribute (which is hereinafter referred to as a “combination user attribute” as well). For example, when a combination of “clothes” and “travel” is high in the frequency of designation by the order request, the accepting unit 23 counts the combination of “clothes” and “travel” as one user attribute.

The information of the order request accepted by the accepting unit 23 is set to the advertising information table of the advertising information DB 11, and the accepting unit 23 can determine a combination of two or more user attributes in which the frequency of designation by the order request is a threshold value or more based on the advertising information table.

For example, the accepting unit 23 obtains the sum of the number of postings designated by a past order request as a first sum value based on the advertising information table, and obtains the sum of the number of postings designated by the past order request for each combination of two or more user attributes as a second sum value. Further, the accepting unit 23 counts a combination of user attributes in which the ratio of the second sum value to the first sum value is a certain threshold value or more as one user attribute.

When the combination of “clothes” and “travel” is high in the frequency of designation by the order request and the future log table is in the state illustrated in FIG. 6, “clothes & travel” is used as the user attribute of the delivery target user of the delivery target ID “F0002” rather than “clothes” and “travel.”

A combination of two or more user attributes in which the frequency of designation by the order request is the threshold value or more may be set to the user information DB 12 from an external apparatus or the like instead of being determined by the accepting unit 23.

Further, for example, when the number of the non-allocated users is the certain value or less or when the number of the non-allocated users having a combination user attribute is the certain value or less, the accepting unit 23 may divide the combination user attribute into a plurality of user attributes. Through this operation, it is possible to increase the total number of the user attributes, and as a result, it is possible to reduce a possibility that the order request designating the combination user attribute will be accepted, and thus it is possible to increase a possibility that other order requests will be accepted.

Score Determining Unit 24

The score determining unit 24 determines the allocation score representing the adequacy degree of the allocation of the delivery target user on the order request based on the number or the proportion of the non-allocated users for each user attribute among the delivery target users set to the future log table. The score determining unit 24 deals with the combination user attribute as one user attribute, similarly to the accepting unit 23.

The score determining unit 24 determines the allocation score according to a determination method of a set determination mode. Examples of the determination mode include a first determination mode, a second determination mode, and a third determination mode, but a combination determination mode thereof may be set. The setting of the determination mode may be performed by an administrator of the advertisement delivery management apparatus 1 using an operating unit (not illustrated) of the advertisement delivery management apparatus 1.

The first determination mode is a mode in which the proportion of the non-allocated users of the user attribute which is smallest in the proportion of the non-allocated users is used as the allocation score. The second determination mode is a mode in which the ratio of the proportion of the non-allocated user to the predictive proportion of each user attribute is calculated for each user attribute, and the smallest value among the calculation results is used as the allocation score.

The third determination mode is a mode in which the ratio of the proportion of the non-allocated user to the predictive proportion of each user attribute is calculated for each user attribute, and the sum value of the calculation results is used as the allocation score. Further, as will be described later, in each determination mode, the “proportion” may be replaced with the “number.”

First of all, the first determination mode will be described. When the first determination mode is set, the score determining unit 24 detects a user attribute (hereinafter also referred to as a “minimum stock user attribute”) of an attribute classification which is smallest in the number of the non-allocated users among the delivery target users set to the future log table. Further, the score determining unit 24 determines the number Aₘᵢₙ of the non-allocated users having the minimum stock user attribute.

For example, when the number of the non-allocated users having the user attribute of the attribute classification “travel” among the attribute classifications set to the future log table illustrated in FIG. 6 is smallest to be “40”, the user attribute of the attribute classification “travel” is set as the minimum stock user attribute. In this case, the score determining unit 24 determines that the number A_{minc} of the non-allocated users having the minimum stock user attribute is “40.”

Further, the score determining unit 24 may determine the proportion Aₘᵢₙₚ of the non-allocated users having the minimum stock user attribute instead of the number A_{minc} of the non-allocated users having the minimum stock user attribute. The proportion Aₘᵢₙₚ is the ratio of the number A_{minc} of the non-allocated users to the total number Aₛᵤₘ of the user attributes of the non-allocated users.

Next, the second determination mode will be described. When the second determination mode is set, the score determining unit 24 determines the proportion Eₚᵢ (which is hereinafter referred to as a “predictive proportion Eₚᵢ,” where, 1<i≦n, i is an attribute number, and n is the total number of the attribute classifications) of the delivery target users set as the future log for each user attribute.

The predictive proportion Eₚᵢ of the user attribute is the ratio of the number of the delivery target users having the corresponding user attribute to the total number of the user attributes. The “total number of user attribute” is a sum value of the number of the delivery target users for each user attribute. Further, the delivery target user includes the non-allocated user and the allocated user.

In the future log illustrated in FIG. 6, for example, the numbers of the delivery target users having the user attributes of the attribute classifications “vehicle,” “cosmetics,” “clothes,” and “travel” are assumed to be “200,” “170,” “130,” and “280,” and the total number of the user attributes is assumed to be “2200 (=200+170+130+280+ . . . ).” Further, the attribute numbers of the attribute classification “vehicle,” “cosmetics,” “clothes,” and “travel” are assumed to be “1,” “2,” “3,” and “4.”

In this case, a proportion Eₚ₁ of the user attribute of the attribute classification “vehicle” is “0.091 (=200/2200),” a proportion Eₚ₂ of the user attribute of the attribute classification “cosmetics” “0.077 (=170/2200),” a proportion Eₚ₃ of the user attribute of the attribute classification “clothes” is “0.059 (=130/2200),” and a proportion Eₚ₄ of the user attribute of the attribute classification “travel” is “0.127 (=280/2200).”

Further, when the second determination mode is set, the score determining unit 24 determines a proportion Aₚᵢ (which is hereinafter referred to as a “stock proportion Aₚᵢ,” where 1<i≦n, i is an attribute number, and n is the total number of the attribute classifications) of the non-allocated users set as the future log for each user attribute. The stock proportion Aₚᵢ of the user attribute is the ratio of the number of the non-allocated users having the corresponding user attribute to the total number of the user attributes. Here, the “total number of user attribute” is a sum value of the number of the non-allocated users for each user attribute.

In the future log illustrated in FIG. 6, for example, the numbers of the non-allocated users having the user attributes of the attribute classification “vehicle,” “cosmetics,” “clothes,” and “travel” are assumed to be “120,” “70,” “90,” and “190,” and the total number of the user attributes is assumed to be “1400 (=120+70+90+190+ . . . ).”

In this case, a stock proportion Aₚ₁ of the user attribute of the attribute classification “vehicle” is “0.086 (=120/1400),” and a stock proportion Aₚ₂ of the user attribute of the attribute classification “cosmetics” is “0.050 (=70/1400).” Further, a stock proportion Aₚ₃ of the user attribute of the attribute classification “clothes” is “0.064 (=90/1400),” and a stock proportion Aₚ₄ of the user attribute of the attribute classification “travel” is “0.135 (=190/1400).”

The score determining unit 24 determines the predictive proportion Eₚᵢ and the stock proportion Aₚᵢ the user attribute, and then sets the minimum ratio Pₚₘᵢₙ among the ratio Pₚᵢ (=Aₚᵢ/Eₚᵢ) of the stock proportion Aₚᵢ to the predictive proportion Eₚᵢ for each user attribute as the allocation score. The ratio Pₚᵢ is the ratio of the user attribute after the stock proportion Aₚᵢ is adjusted by the predictive proportion Eₚᵢ, and is hereinafter referred to as an “adjusted ratio Pₚᵢ.”

For example, in the future log illustrated in FIG. 6, the predictive proportions Eₚ₁, Eₚ₂, Eₚ₃, and Eₚ₄ of the user attribute are assumed to be 0.091, 0.077, 0.059, and 0.127, and the stock proportions Aₚ₁, Aₚ₂, Aₚ₃, and Aₚ₄ are assumed to be 0.086, 0.050, 0.064, and 0.135 as described above.

In this case, the adjusted ratios Pₚ₁, Pₚ₂, Pₚ₃, and Pₚ₄ are 0.95, 0.85, 1.09, and 1.63. Thus, among the adjusted ratios Pₚ₁, Pₚ₂, Pₚ₃, and Pₚ₄, the smallest adjusted ratio Pₚₘᵢₙ is the adjusted ratio Pₚ₂ corresponding to the user attribute of the attribute classification “cosmetics,” and the score determining unit 24 determines the smallest adjusted ratio Pₚₘᵢₙ=0.85 as the allocation score.

In the above example, the score determining unit 24 determines the smallest ratio among the ratios Pₚᵢ (=Aₚᵢ/Eₚᵢ) of the stock proportion Aₚᵢ to the predictive proportion Eₚᵢ for each user attribute as the allocation score, but may determine the smallest ratio among ratios P_{ci} (=A_{ci}/E_{ci}) of a stock number A_{ci} to a predictive number E_{ci} for each user attribute as the allocation score. Here, “i” is an attribute number as described above.

The predictive number E_{ci} of each user attribute is the number of delivery target users of each user attribute in the future log table, and the stock number A_{ci} of each user attribute is the number of the non-allocated users of each user attribute in the future log table. Further, the ratio P_{ci} is the ratio of the user attribute after the stock number A_{ci} is adjusted by the predictive number E_{ci}, and is hereinafter referred to as an “adjusted ratio P_{ci}.”

For example, in the future log illustrated in FIG. 6, the predictive numbers E_{c1}, E_{c2}, E_{c3}, and E_{c4} of the user attribute are assumed to be 200, 170, 130, and 280, and the stock numbers A_{c1}, A_{c2}, A_{c3}, and A_{c4} are assumed to be 120, 70, 90, and 190 as described above.

In this case, the adjusted ratios P_{c1}, P_{c2}, P_{c3}, and P_{c4} are 0.6, 0.41, 0.69, and 0.68. Thus, among the adjusted ratios P_{c1}, P_{c2}, P_{c3}, and P_{c4}, the smallest adjusted ratio P_{cmin} is the adjusted ratio P_{c2} corresponding to the user attribute of the attribute classification “cosmetics,” and the score determining unit 24 determines the smallest adjusted ratio P_{cmin} (=0.41) as the allocation score.

Next, the third determination mode will be described. Similarly to when the second determination mode is set, when the third determination mode is set, the score determining unit 24 determines the adjusted ratio Pₚᵢ (=Aₚᵢ/Eₚᵢ) which is the ratio of the stock proportion Aₚᵢ to the predictive proportion Eₚᵢ for each user attribute. Further, the score determining unit 24 determines a sum value Pₚₛᵤₘ (=ΣPₚᵢ) of the adjusted ratios Pₚᵢ as the allocation score.

For example, in the future log illustrated in FIG. 6, the predictive proportions Eₚ₁, Eₚ₂, Eₚ₃, and Eₚ₄ of the user attribute are assumed to be 0.091, 0.077, 0.059, and 0.127, and the stock proportion Aₚ₁, Aₚ₂, Aₚ₃, and Aₚ₄ are assumed to be 0.086, 0.050, 0.064, and 0.135 as described above.

In this case, the adjusted ratios Pₚ₁, Pₚ₂, Pₚ₃, and Pₚ₄ are 0.95, 0.85, 1.09, and 1.63. Thus, the score determining unit 24 determines the sum value Pₚₛᵤₘ (=0.95+0.85+1.09+1.63=4.52) of the adjusted ratios as the allocation score.

In the above example, the score determining unit 24 may determine the sum value P_{csum} (=ΣP_{ci}) of the ratios P_{ci} (=A_{ci}/E_{ci}) of the stock number A_{ci} to the predictive number E_{ci} for each user attribute as the allocation score.

For example, in the future log illustrated in FIG. 6, the predictive numbers E_{c1}, E_{c2}, E_{c3}, and E_{c4} of the user attribute are assumed to be 200, 170, 130, and 280, and the stock numbers A_{c1}, A_{c2}, A_{c3}, and A_{c4} are assumed to be 120, 70, 90, and 190 as described above. In this case, the adjusted ratios P_{c1}, P_{c2}, P_{c3}, and P_{c4} are 0.6, 0.41, 0.69, and 0.68. Thus, the score determining unit 24 determines the sum value P_{csum} (=0.6+0.41+0.69+0.68=2.38) of the adjusted ratios as the allocation score.

When the number Aₘᵢₙ of the users, the smallest adjusted ratios Pₚₘᵢₙ and P_{cmin}, or the sum values Pₚₛᵤₘ and P_{csum} of the adjusted ratios is determined as the allocation score, it means that the values are actually used as the allocation score, and the present invention is not limited to the example in which the values are used as the allocation score as is.

Allocating Unit 25

The allocating unit 25 allocates the delivery target user on the advertisement delivery order request accepted by the accepting unit 23 so that the decrease in the allocation score determined by the score determining unit 24 is minimized before and after the delivery target user is allocated on the order request. The allocating unit 25 deals the combination user attribute as one user attribute, similarly to the accepting unit 23.

Specifically, the allocating unit 25 selects, by the number of postings designated by the order request, the non-allocated user having the user attribute designated by the advertisement delivery order request from the future log table, and acquires the decrease value of the allocation score before and after the selected non-allocated users are allocated on the order request from the score determining unit 24.

Except when the non-allocated users having the user attribute designated by the advertisement delivery order request are set to the future log table by the number of postings designated by the order request, the number of the combinations of the non-allocated users which are equal to the number of postings designated by the order request is two or more. For example, when the number of the non-allocated users having the user attribute designated by the advertisement delivery order request is “10” and when the number of postings designated by the order request is “5,” the number of the combinations of the non-allocated users is “252.”

The allocating unit 25 acquires the decrease values of the allocation scores before and after allocation on the order request from the score determining unit 24 for all the combinations of the non-allocated users which are equal to the number of postings designated by the order request, and determines a combination of the non-allocated users which are smallest in the decrease value of the allocation score. Further, the non-allocated users of the combination determined to be smallest in the decrease value are selected and allocated on the order request.

Further, the allocating unit 25 may select, by the number of postings designated by the order request, the non-allocated user having the user attribute designated by the order request so that the decrease in the allocation score can be minimized under a certain limitation.

For example, a limitation in which the non-allocated users are allocated so that the decrease in the allocation score is minimized within a range in which a decrease rate of the user attribute other than the user attribute designated by the order request is a certain rate or less may be set as the certain limitation.

Further, a limitation in which the non-allocated users are allocated so that the decrease in the allocation score is minimized within a range in which a decrease rate of an expectation value at which all the user attributes are allocated is a certain value or less when the user attributes are designated randomly or according to a certain rule on the advertisement delivery order request can be set as the certain limitation.

### 3. Process Flow of Advertisement Delivery Management Apparatus 1

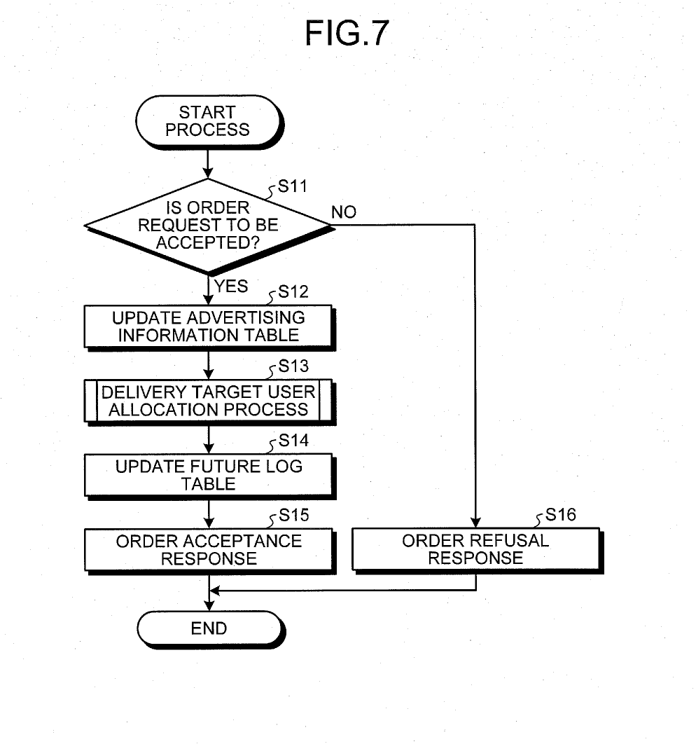

Next, a procedure of an advertisement delivery management process performed by the advertisement delivery management apparatus 1 according to an embodiment will be described. FIG. 7 is a diagram illustrating an advertisement delivery management process flow of the advertisement delivery management apparatus 1 according to an embodiment.

As illustrated in FIG. 7, when the order request is received from the advertiser terminal 3, the control unit 15 of the advertisement delivery management apparatus 1 determines whether the order request received from the advertiser terminal 3 is to be accepted based on the future log set to the future log table (step S11). For example, the control unit 15 counts the number of user attributes designated by the order request among the user attributes of the non-allocated user set to the future log table, and determines that the order request is accepted when the counted number is the number of postings designated by the order request or more.

When it is determined that the order request received from the advertiser terminal 3 is accepted (Yes in step S11), the control unit 15 sets information included in the order request to the advertising information table and updates the advertising information table (step S12). Further, the information included in the order request includes the user attribute, the posting period of time, the number of postings, advertising information, and the like, and the information is set to the advertising information table.

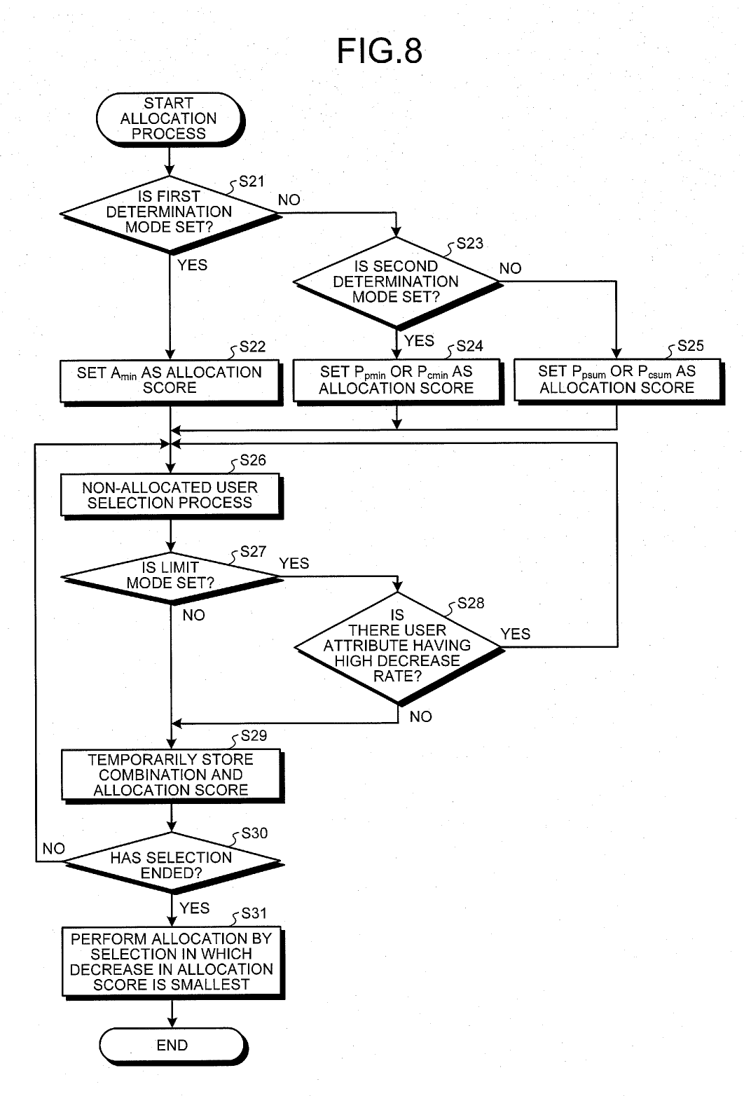

Then, the control unit 15 performs the delivery target user allocation process (step S13). The allocation process is a process of allocating the non-allocated user having the user attribute designated by the order request on the order request such as a process of steps S21 to S25 of FIG. 8 which will be described later.

Then, the control unit 15 updates the future log table based on the result of the allocation process of step S13 (step S14). Specifically, the control unit 15 changes the non-allocated user allocated on the order request among the non-allocated users set to the future log table to the allocated user. The changing the non-allocated user to the allocated user is performed by changing the “allocation state” from “0”.

Thereafter, the control unit 15 transmits the order acceptance response to the advertiser terminal 3 through the communication unit 10 (step S15), and then ends the advertisement delivery management process. Meanwhile, when it is determined in step S11 that the order request received from the advertiser terminal 3 is not to be accepted (No in step S11), the control unit 15 transmits the order refusal response to the advertiser terminal 3 through the communication unit 10 (step S16), the advertisement delivery management process.

Next, an example of the allocation process of step S13 will be concretely described with reference to FIG. 8. FIG. 8 is a diagram illustrating an exemplary allocation process flow of the advertisement delivery management apparatus 1 according to an embodiment.

As illustrated in FIG. 8, when the delivery target user allocation process starts, the control unit 15 of the advertisement delivery management apparatus 1 determines whether the first determination mode is set (step S21). When it is determined that the first determination mode is set (Yes in step S21), the control unit 15 sets the number Aₘᵢₙ of the non-allocated users having the minimum stock user attribute to the allocation score (step S22).

When it is determined in step S21 that the first determination mode is not set (No in step S21), the control unit 15 determines whether the second determination mode is set (step S23). When it is determined that the second determination mode is set (Yes in step S23), the control unit 15 sets the smallest adjusted ratio Pₚₘᵢₙ or the smallest adjusted P_{cmin} as the allocation score (step S24).

When it is determined in step S23 that the second determination mode is not set (No in step S23), the control unit 15 determines that the third determination mode is set, and sets the sum value Pₚₛᵤₘ of the adjusted ratios or the sum value P_{csum} of the adjusted ratios as the allocation score (step S25).

When the process of step S22, S24, or S25 ends, the control unit 15 selects the non-allocated user having the user attribute designated by the advertisement delivery order request from the future log table by the number of postings designated by the order request (step S26).

Then, the control unit 15 determines whether a limit mode is set (step S27). The setting of the limit mode may be performed, for example, by the administrator of the advertisement delivery management apparatus 1 using an operating unit (not illustrated) of the advertisement delivery management apparatus 1. Further, when the number of the non-allocated users in the future log table is certain number or less, the control unit 15 may set the limit mode.

When it is determined that the limit mode is not set (No in step S27), the control unit 15 causes the process to proceed to step S29. However, when it is determined that the limit mode is set (Yes in step S27), the control unit 15 determines whether there is a user attribute which is high in the decrease rate (step S28). In this process, the control unit 15 obtains the decrease rate of each user attribute of the non-allocated user before and after the non-allocated user selected in step S26 is allocated on the order request, and determines the user attribute in which the decrease rate is a certain value or more as the user attribute having the high decrease rate.

When it is determined that there is a user attribute in which the decrease rate is the certain value or more (Yes in step S28), the control unit 15 causes the process to return to step S26, and selects the non-allocated users of the different combination by the number of postings. However, when it is determined that there is no user attribute in which the decrease rate is the certain value or more (No in step S28), and the control unit 15 causes the process to proceed to step S29.

In step S29, the control unit 15 temporarily stores the combination of the non-allocated users and the allocation score. When the process ends, the control unit 15 determines whether the selection of the non-allocated user has ended (step S30). Specifically, when the selection of the combination of the non-allocated users which are equal to the number of postings designated by the order request is performed on all combinations in step S26, the control unit 15 determines that the selection of the non-allocated user has ended.

When it is determined that the selection of the non-allocated user has not ended (No in step S30), the control unit 15 causes the process to return to step S26, and selects the non-allocated users of the different combination by the number of postings. However, when it is determined that the selection of the non-allocated user has ended (Yes in step S30), the control unit 15 allocates the order request to the non-allocated users of the combination which is smallest in the decrease in the allocation score (step S31), and then ends the delivery target user allocation process. The process of step S31 is performed based on the combination of the non-allocated users and the allocation score temporarily stored in step S29.

### 4. Modified Example

In the embodiment, the allocating unit 25 performs the allocation process of allocating the delivery target user on the order request each time the order request is received from the advertiser terminal 3, but may perform the allocation process in units of two or more order requests. Further, the allocating unit 25 may perform the allocation process each time a total of the number of postings designated by the order request is a certain number or more. In this case, the accepting unit 23 can perform the allocation process efficiently and more appropriately while rapidly performing the acceptance process by accepting the order request each time the order request is received from the advertiser terminal.

Further, in order to help under the description, the above embodiment has been described in connection with the example in which the target period of time in which the future advertisement delivery destination is predicted is identical to the posting period of time of the order request. However, the target period of time in which the future advertisement delivery destination is predicted may not be identical to the posting period of time of the order request, and the target period of time in which the future advertisement delivery destination is predicted may be set in units of one days, and the posting period of time of the order request may be set in units of one days. Further, a part of the target period of time in which the future advertisement delivery destination is predicted may be used as the posting period of time of the order request.

Further, in the above embodiment, the allocation score is determined by the first to third determination modes, but the allocation score may be determined by any other determination method. For example, the score determining unit 24 may determine the stock number A_{ci} or the stock proportion Aₚᵢ of the non-allocated user of the user attribute which is smallest in the predictive number E_{ci} or the predictive proportion Pₚᵢ as the allocation score. In this case, it is possible to increase a possibility of acceptance of the order request designating the user attribute which is unlikely to be designated in the order request.

Further, in the above embodiment, it is possible to change the first to third determination modes by setting, but the first to third determination modes may be switched according to a total of the number of the user attributes of the non-allocated users. For example, when a total of the number of the user attributes is a first threshold value or more, when a total of the number of the user attributes is less than the first threshold value and is a second threshold value or more, and when a total of the number of the user attributes is less than the second threshold value, determination modes used to determine the allocation score may be different.

Further, in the above embodiment, the process on the order request has been described, but the control unit 15 may receive an advertisement delivery cancellation request from the advertiser terminal 3. In this case, the allocating unit 25 changes the allocated user to the non-allocated user on the advertisement delivery cancellation request received by the accepting unit 23 so that an increase in the allocation score determined by the score determining unit 24 can be maximized before and after the allocated user is changed to the non-allocated user on the advertisement delivery cancellation request.

Further, the above embodiment has been described in connection with the example in which the user attribute is designated in the order request, but even when the user attribute is not designated in the order request, the allocating unit 25 may allocate the delivery target user so that the decrease in the allocation score can be minimized.

Further, the above embodiment has been described in connection with the example in which one or more user attributes are designated in the advertisement delivery order, but the user attribute may be selectively designated in the advertisement delivery order. For example, the advertisement delivery order may be given on the user of either the user attribute in which the attribute classification of “vehicle” or the user attribute in which the attribute classification is “travel.” In this case, similarly, the allocating unit 25 allocates the delivery target user so that the decrease in the allocation score can be minimized.

### 5. Effects

In the advertisement delivery management apparatus 1 according to the embodiment, the future log DB 14 (which corresponds to an example of a predictive information storage unit) stores a future log (which corresponds to an example of predictive information) including user attributes of a plurality of delivery target users predicted as a future advertisement delivery destination, the score determining unit 24 (which corresponds to an example of a score determining unit) determines an allocation score representing a adequacy degree of allocation of a delivery target user on an advertisement delivery order request based on the number or the proportion of non-allocated users which are delivery target users which are not allocated on the advertisement delivery order request among a plurality of delivery target users for each user attribute, and the allocating unit 25 (which corresponds to an example of an allocating unit) allocates the delivery target user on the advertisement delivery order request so that the decrease in the allocation score can be minimized before and after the delivery target user is allocated on the advertisement delivery order request.

Through this configuration, it is possible to make appropriate the number or the proportion of the non-allocated users for each user attribute, and it is possible to suppress a decrease in the likelihood of acceptance of a future advertisement delivery order request, and thus it is possible to suppress sales opportunity loss.

Further, in the advertisement delivery management apparatus 1 according to the embodiment, the score determining unit 24 determines the number A_{minc} or the proportion Aₘᵢₙₚ of the non-allocated users of the user attribute which is smallest in the number or the proportion of the non-allocated users as the allocation score.

Through this configuration, it is possible to suppress a decrease in the number of the user attributes which are smallest in the number or the proportion of the non-allocated users, and thus it is possible to increase the likelihood of acceptance of an order request designating a user attribute which is unlikely to be, designated in an order request. Further, as a user attribute which is likely to be designated in an order request is allocated on the order request, similarly to when the number of the non-allocated users is small, it is possible to increase the likelihood of acceptance of the order request designating the user attribute.

Further, in the advertisement delivery management apparatus 1 according to the embodiment, the score determining unit 24 obtains the predictive number E_{ci} or the predictive proportion Eₚᵢ of the delivery target users for each user attribute with reference to the future log table, calculates the ratio P_{ci} or Pₚᵢ of the number A_{ci} of the non-allocated users or the predictive proportion Aₚᵢ to the predictive number E_{ci} or the predictive proportion Eₚᵢ for each user attribute and determines the adjusted ratio P_{cmin} or Pₚₘᵢₙ which is the smallest value among the calculated ratios as the allocation score.

Through this configuration, it is possible to suppress a decrease in the number of the non-allocated uses of the user attribute which is largest in the decrease amount of the non-allocated user compared to the probability of designation in the order request, and thus it is possible to increase the likelihood of acceptance of the order request designating the user attribute.

Further, in the advertisement delivery management apparatus 1 according to the embodiment, the score determining unit 24 obtains the predictive number E_{ci} or the predictive proportion Eₚᵢ of the delivery target users for each user attribute with reference to the future log table, calculates the ratio P_{ci} or Pₚᵢ of the stock number A_{ci} or the stock proportion Aₚᵢ of the non-allocated users to the predictive number E_{ci} or the predictive proportion Eₚᵢ for each user attribute, and determines the sum value P_{csum} or Pₚₛᵤₘ of the calculated ratios as the allocation score.

Through this configuration, it is possible to suppress a decrease in the number of the non-allocated uses of the user attribute which is large in the decrease amount of the non-allocated users compared to the probability of designation in the order request, and thus it is possible to generally increase the likelihood of acceptance of the order request.

Further, in the advertisement delivery management apparatus 1 according to the embodiment, the allocating unit 25 allocates the delivery target user so that the decrease in the allocation score is minimized within a range in which a decrease in the expectation value at which all user attributes are allocated is a certain value or less when the user attribute is designated by the order request randomly or according to a certain rule.

Through this configuration, it is possible to prevent some user attributes from extremely decreasing, and thus it is possible to increase the likelihood of acceptance of future advertisement delivery order request, and it is possible to suppress sales opportunity loss.

Further, in the advertisement delivery management apparatus 1 according to the embodiment, the allocating unit 25 allocates the delivery target user using a combination of two or more user attributes in which the frequency of designation by the advertisement delivery order request is a threshold value or more as one user attribute.

Through this configuration, it is possible to allocate the user attribute on the order request using a combination of two or more user attributes in which the frequency of designation by the advertisement delivery order request is a threshold value or more, and thus it is possible to increase the likelihood of acceptance of a future advertisement delivery order request, and it is possible to suppress sales opportunity loss.

### 6. Others

The advertisement delivery management apparatus mentioned above may be implemented by a plurality of server computers or may be implemented by calling an external platform or the like through an application programming interface (API), network computing, or the like according to a function. That is, the configuration of advertisement delivery management apparatus 1 can be flexibly changed. Further, the advertisement delivery management apparatus 1 and the information delivery apparatus 2 may be implemented by a single server computer.

According to the aspect of an embodiment, it is possible to provide an advertisement delivery management apparatus and an advertisement delivery management method which are capable of appropriately allocating the delivery target user on the advertisement delivery order.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An advertisement delivery management apparatus, comprising:
a predictive information storage configured to store predictive information including user attributes of a plurality of delivery target users predicted as a future advertisement delivery destination;
a score determining unit configured to determine an allocation score representing a adequacy degree of allocation of a delivery target user on an advertisement delivery order request based on a number or a proportion of non-allocated users which are delivery target users which are not allocated on the advertisement delivery order request among the plurality of delivery target users for each user attribute; and
an allocating unit configured to allocate the delivery target user on the advertisement delivery order request so that a decrease in the allocation score is minimized before and after the delivery target user is allocated on the advertisement delivery order request.

2. The advertisement delivery management apparatus according to claim 1,
wherein the score determining unit determines the number or the proportion of the non-allocated users of a user attribute which is smallest in the number or the proportion of the non-allocated users as the allocation score.

3. The advertisement delivery management apparatus according to claim 1,
wherein the score determining unit obtains a predictive number or a predictive proportion of delivery target users for each user attribute with reference to the predictive information, calculates a ratio of the number or the proportion of the non-allocated users to the predictive number or the predictive proportion for each user attribute, and determines the smallest value among the calculated ratios as the allocation score.

4. The advertisement delivery management apparatus according to claim 1,
wherein the score determining unit obtains a predictive number or a predictive proportion of delivery target users for each user attribute with reference to the predictive information, calculates a ratio of the number or the proportion of the non-allocated users to the predictive number or the predictive proportion for each user attribute, and determines a sum value of the calculated ratios as the allocation score.

5. The advertisement delivery management apparatus according to claim 1,
wherein the allocating unit allocates the delivery target user so that a decrease in the allocation score is minimized within a range in which a decrease in an expectation value at which all user attributes are allocated is a certain value or less when the user attribute is designated by the advertisement delivery order request randomly or according to a certain rule.

6. The advertisement delivery management apparatus according to claim 1,
wherein the allocating unit allocates the delivery target user using a combination of two or more user attributes in which a frequency of designation by the advertisement delivery order is a threshold value or more as a single user attribute.

7. An advertisement delivery management method performed by a computer, comprising:
determining an allocation score representing an adequacy degree of allocation of a delivery target user on an advertisement delivery order request based on a number or a proportion of delivery target users which are not allocated on the advertisement delivery order request among a plurality of delivery target users predicted as a future advertisement delivery destination for each user attribute; and
allocating the delivery target user on the advertisement delivery order request so that a decrease in the allocation score is minimized before and after the delivery target user is allocated on the advertisement delivery order request for the advertisement delivery order request.

8. The advertisement delivery management method according to claim 7,
wherein the determining includes determining the number or the proportion of the non-allocated users of a user attribute which is smallest in the number or the proportion of the non-allocated users as the allocation score.

9. The advertisement delivery management method according to claim 7,
wherein the determining includes obtaining a predictive number or a predictive proportion of delivery target users for each user attribute with reference to the predictive information, calculating a ratio of the number or the proportion of the non-allocated users to the predictive number or the predictive proportion for each user attribute, and determining the smallest value among the calculated ratios as the allocation score.

10. The advertisement delivery management method according to claim 7,
wherein the determining includes obtaining a predictive number or a predictive proportion of delivery target users for each user attribute with reference to the predictive information, calculating a ratio of the number or the proportion of the non-allocated users to the predictive number or the predictive proportion for each user attribute, and determining a sum value of the calculated ratios as the allocation score.

11. The advertisement delivery management method according to claim 7,
wherein the allocating includes allocating the delivery target user so that a decrease in the allocation score is minimized within a range in which a decrease in an expectation value at which all user attributes are allocated is a certain value or less when the user attribute is designated by the advertisement delivery order request randomly or according to a certain rule.

12. The advertisement delivery management method according to claim 7,
wherein the allocating includes allocating the delivery target user using a combination of two or more user attributes in which a frequency of designation by the advertisement delivery order request is a threshold value or more as a single user attribute.
